(19) United States
(12) Patent Application Publication
(10) Pub. No.: US 2018/0025447 A1
(43) Pub. Date: Jan. 25, 2018

(54) MANAGEMENT METHOD AND SYSTEM FOR UNMANNED VEHICLES, DISPATCH CENTER PLATFORM, AND UNMANNED VEHICLE

(71) Applicant: BAIDU ONLINE NETWORK TECHNOLOGY (BEIJING) CO., LTD., BEIJING (CN)

(72) Inventor: TAIQUN HU, BEIJING (CN)

(73) Assignee: BAIDU ONLINE NETWORK TECHNOLOGY (BEIJING) CO., LTD., BEIJING (CN)

(21) Appl. No.: 15/402,849

(22) Filed: Jan. 10, 2017

(30) Foreign Application Priority Data
Jul. 21, 2016 (CN) 201610579335.2

(51) Int. Cl. G06Q 50/14; G06Q 10/06; G08G 1/00; G07C 5/02; G08G 1/127

(52) U.S. Cl. CPC G06Q 50/14; G07C 5/02; G08G 1/127; G08G 1/202; G06Q 10/06315

(57) ABSTRACT

The present information provides a method and system for managing unmanned vehicles, a dispatch center platform, and an unmanned vehicle. The managing method comprises: obtaining the number of tickets purchased by tourists; determining a dispatch unmanned vehicle based on the number of purchased tickets and preset numbers of seats of respective unmanned vehicles; sending a dispatch instruction message to the dispatch unmanned vehicle for the dispatch unmanned vehicle to travel to a departure location to pick up tourists. The technical solution of the present embodiment can realize automatic dispatching of unmanned vehicles, and does not need manual dispatching or manual driving, thus effectively saving operating cost of the attraction spots. And through management and control of unmanned vehicles by the dispatch center platform, it is possible to greatly improve management precision of the infrastructure in attraction spots, effectively improve the operating efficiency of attraction spots, and improve the tourists' interest and experiences.

### TECHNICAL FIELD

The present invention relates to the field of tourism equipment, and more particularly, to a method and system for managing unmanned vehicles, a dispatch center platform, and an unmanned vehicle.

### BACKGROUND

With the development of science and technology and people's material and cultural enrichment, more and more people begin to pursue spiritual and cultural life. For example, more and more people travel out of the house to broaden their minds and cultivate sentiment in their spare time.

In traditional tourism industry, there are fewer tourists, management of tourist attraction spots and infrastructure maintenance are all done manually. For example, all tourist buses in the attraction area are driven manually. The staff at the attraction spots management center dispatches tourist buses, requires the tourist buses to enter stations to pick up tourists, has special staff to check the tickets of tourists, and has the buses to start traveling based on the attraction spot management center so as to send the tourists to the destination. In addition, during traveling of the tourist buses, the staff can also introduce the attraction spots to help tourists understand the area.

Notwithstanding the above, in recent years, with the proliferation of tourism industry, the traditional model of manual operation of the attraction infrastructure has the disadvantage of high cost, poor precision, and low efficiency of human operation.

### SUMMARY

The present information provides a method and system for managing unmanned vehicles, a dispatch center platform, and an unmanned vehicle to reduce the operation cost of human operation and improve efficiency of the attraction spot operation.

The present invention provides a managing method for unmanned vehicles, wherein the method comprises:

obtaining the number of tickets purchased by tourists;

determining a dispatch unmanned vehicle based on the number of purchased tickets and preset numbers of seats of respective unmanned vehicles;

sending a dispatch instruction message to the dispatch unmanned vehicle for the dispatch unmanned vehicle to travel to a departure location to pick up tourists.

Further optionally, in the above method, after the step of sending a dispatch instruction message to the dispatch unmanned vehicle, the method further comprises:

detecting whether the dispatch unmanned vehicle arrives at the departure location;

sending a check-in instruction message to the dispatch unmanned vehicle when the dispatch unmanned vehicle arrives at the departure location, for the dispatch unmanned vehicle to start checking tickets of tourists and open a boarding passage so as to allow the tourists to board the car;

detecting whether the number of tickets checked to be valid by the unmanned vehicle reaches a preset number of seats of the dispatch unmanned vehicle;

sending, when the number of tickets checked to be valid reaches the preset number of seats, a check-in stop message to the dispatch unmanned vehicle, for the dispatch unmanned vehicle to stop ticket checking;

sending a departure instruction message to the dispatch unmanned vehicle for the dispatch unmanned vehicle to start traveling in accordance with a preset route.

Further optionally, in the above method, the method further comprises:

further detecting whether the dispatch unmanned vehicle has stayed at the departure location for a time period greater than or equal to a preset duration when it is detected that the number of tickets checked to be valid by the dispatch unmanned vehicle does not reach the preset number of seats of the dispatch unmanned vehicle;

sending a departure instruction message to the dispatch unmanned vehicle when it is detected that the dispatch unmanned vehicle has stayed at the departure location for a time period greater than or equal to a preset duration.

The present invention also provides a managing method for unmanned vehicles, wherein the method comprises:

receiving a dispatch instruction message sent by a dispatch center platform, the dispatch instruction message being the number of tickets purchased by tourists obtained by the dispatch center platform and sent to a dispatch unmanned vehicle after the dispatch unmanned vehicle is determined based on the number of purchased tickets and preset numbers of seats of respective unmanned vehicles;

controlling, based on the dispatch instruction message, the dispatch unmanned vehicle to travel to a departure location to pick up tourists.

Further optionally, in the above method, after the step of controlling, based on the dispatch instruction message, the dispatch unmanned vehicle to travel to a departure location, the method further comprises:

receiving, after the vehicle travels to the departure location, a check-in instruction message sent by the dispatch center platform;

obtaining identifier information of the ticket of a tourist based on the check-in instruction message;

sending the identifier information of the ticket to a check-in server for the check-in server to check the authenticity of the ticket based on the identifier information of the ticket and to check whether the ticket is checked in repeatedly;

receiving checking information of the ticket returned by the check-in server;

and performing corresponding processing based on the checking information of the ticket.

Further optionally, in the above method, performing corresponding processing based on the checking information of the ticket comprises:

opening a boarding passage to allow the tourist to board the vehicle if the ticket is authentic and is not checked in repeatedly;

issuing a prompt message stating that the ticket has been checked in and no boarding is allowed if the ticket is authentic but is checked in repeatedly;

issuing a prompt message stating that the ticket is faked and no boarding is allowed if the ticket is faked,

further, the method also comprises:

sending a message stating that the ticket is checked to be valid to the dispatch center platform so as to enable the dispatch center platform to count the number of tickets checked to be valid, if the ticket is authentic and is not checked in repeatedly.

Further optionally, in the above method, after the step of sending a message stating that the ticket is checked to be valid to the dispatch center platform, the method further comprises:

receiving a check-in stop message sent by the dispatch center platform if the number of tickets checked to be valid by the dispatch unmanned vehicle reaches a preset number of seats of the dispatch unmanned vehicle or the dispatch unmanned vehicle has stayed at the departure location for a time period greater than or equal to a preset duration;

stopping check-in based on the check-in stop message;

receiving a departure instruction message sent by the dispatch center platform;

and starting traveling according to a preset route based on the departure instruction message.

Further optionally, in the above method, after traveling according to a preset route based on the departure instruction message, the method further comprises:

displaying a tour route map of a preset route and information of all attraction spots;

displaying a selection box for the attraction spots;

receiving selection information of the attraction spot selected by a tourist based on the selection box of the attraction spots;

issuing a disembarking instruction message upon arrival at the attraction spot selected by the tourist.

The present invention also provides a dispatch center platform, wherein the platform comprises:

an obtaining module, for obtaining the number of tickets purchased by tourists;

a determining module, for determining a dispatch unmanned vehicle based on the number of purchased tickets and preset numbers of seats of respective unmanned vehicles;

a transmission module, for sending a dispatch instruction message to the dispatch unmanned vehicle for the dispatch unmanned vehicle to travel to a departure location to pick up tourists.

Further optionally, in the above platform, the platform further comprises a detecting module,

the detecting module is used for detecting whether the dispatch unmanned vehicle arrives at the departure location;

the transmission module is also used for sending a check-in instruction message to the dispatch unmanned vehicle when the dispatch unmanned vehicle arrives at the departure location, for the dispatch unmanned vehicle to start checking tickets of tourists and open a boarding passage so as to allow the tourists to board the car;

the detecting module is also used for detecting whether the number of tickets checked to be valid by the unmanned vehicle reaches a preset number of seats of the dispatch unmanned vehicle;

the transmission module is also used for sending, when the number of tickets checked to be valid reaches the preset number of seats, a check-in stop message to the dispatch unmanned vehicle, for the dispatch unmanned vehicle to stop ticket checking;

the transmission module is also used for sending a departure instruction message to the dispatch unmanned vehicle for the dispatch unmanned vehicle to start traveling in accordance with a preset route.

Further optionally, in the above platform, the detecting module is also used for further detecting whether the dispatch unmanned vehicle has stayed at the departure location for a time period greater than or equal to a preset duration when it is detected that the number of tickets checked to be valid by the dispatch unmanned vehicle does not reach the preset number of seats of the dispatch unmanned vehicle;

the transmission module is also used for sending a departure instruction message to the dispatch unmanned vehicle when it is detected that the dispatch unmanned vehicle has stayed at the departure location for a time period greater than or equal to a preset duration.

The present invention also provides an unmanned vehicle, wherein the unmanned vehicle comprises:

a receiving module, for receiving a dispatch instruction message sent by a dispatch center platform, the dispatch instruction message being the number of tickets purchased by tourists obtained by the dispatch center platform and sent to a dispatch unmanned vehicle after the dispatch unmanned vehicle is determined based on the number of purchased tickets and preset numbers of seats of respective unmanned vehicles;

a control module, for controlling, based on the dispatch instruction message, the dispatch unmanned vehicle to travel to a departure location to pick up tourists.

Further optionally, in the above unmanned vehicle, the unmanned vehicle further comprises an obtaining module, a transmission module, and a processing module, the receiving module is also used for receiving, after the vehicle travels to the departure location, a check-in instruction message sent by the dispatch center platform;

the obtaining module is used for obtaining identifier information of the ticket of a tourist based on the check-in instruction message;

the transmission module is used for sending the identifier information of the ticket to a check-in server for the check-in server to check the authenticity of the ticket based on the identifier information of the ticket and to check whether the ticket is checked in repeatedly;

the receiving module is also used for receiving checking information of the ticket returned by the check-in server;

the processing method is used for performing corresponding processing based on the checking information of the ticket.

Further optionally, in the above unmanned vehicle, the processing module is specifically used for opening a boarding passage to allow the tourist to board the vehicle if the ticket is authentic and is not checked in repeatedly;

the processing module is also specifically used for issuing a prompt message stating that the ticket has been checked in and no boarding is allowed if the ticket is authentic but is checked in repeatedly;

the processing module is also specifically used for issuing a prompt message stating that the ticket is faked and no boarding is allowed if the ticket is faked,

further, the transmission module is also used for sending a message stating that the ticket is checked to be valid to the dispatch center platform so as to enable the dispatch center platform to count the number of tickets checked to be valid, if the ticket is authentic and is not checked in repeatedly.

Further optionally, in the above unmanned vehicle, the receiving module is also used for receiving a check-in stop message sent by the dispatch center platform if the number of tickets checked to be valid by the dispatch unmanned vehicle reaches a preset number of seats of the dispatch unmanned vehicle or the dispatch unmanned vehicle has stayed at the departure location for a time period greater than or equal to a preset duration;

the control module is also used for stopping check-in based on the check-in stop message;

the receiving module is also used for receiving a departure instruction message sent by the dispatch center platform;

the control module is also used for starting traveling according to a preset route based on the departure instruction message.

Further optionally, in the above unmanned vehicle, the unmanned vehicle further comprised a displaying module:

the displaying module is used for displaying a tour route map of a preset route and information of all attraction spots;

the displaying module is also used for displaying a selection box for the attraction spots;

the receiving module is also used for receiving selection information of the attraction spot selected by a tourist based on the selection box of the attraction spots;

the processing module is also used for issuing a disembarking instruction message upon arrival at the attraction spot selected by the tourist.

The present invention also provides a management system for unmanned vehicles, wherein the system comprises a dispatch center platform and at least one unmanned vehicle; said dispatch center platform being in communication with each of said unmanned vehicles to effect management of unmanned vehicles;

the dispatch center platform employs the above dispatch center platform o; each of the unmanned vehicles employs the above unmanned vehicle.

With the technical solutions of the managing methods and system, dispatch center platform, and unmanned vehicle, unmanned vehicles can be dispatched automatically by the dispatch center platform, to overcome the disadvantages of human operation of the attraction spot infrastructure in prior art, which can lead to high labor cost and low working efficiency. It can realize automatic dispatching of unmanned vehicles, and does not need manual dispatching or manual driving, thus effectively saving operating cost of the attraction spots. And through management and control of unmanned vehicles by the dispatch center platform, it is possible to greatly improve management precision of the infrastructure in attraction spots, effectively improve the operating efficiency of attraction spots, and improve the tourists' interest and experiences.

### BRIEF DESCRIPTION OF DRAWINGS

FIG. 1 is a flowchart of a first embodiment of the managing method for unmanned vehicles according to the present invention.

FIG. 2 is a flowchart of a second embodiment of the managing method for unmanned vehicles according to the present invention;

FIG. 3 is a schematic structural view of an embodiment of a dispatch center platform according to the present invention.

FIG. 4 is a schematic structural view of an unmanned vehicle according to a first embodiment of the present invention.

FIG. 5 is a schematic structural view of an unmanned vehicle according to a second embodiment of the present invention. Fig.

FIG. 6 is a structural diagram of an embodiment of a management system for unmanned vehicles according to the present invention.

### DETAILED DESCRIPTION

To show the objects, technical solutions, and advantages of the present invention more apparently, the invention will be described in detail with reference to the accompanying drawings and specific examples.

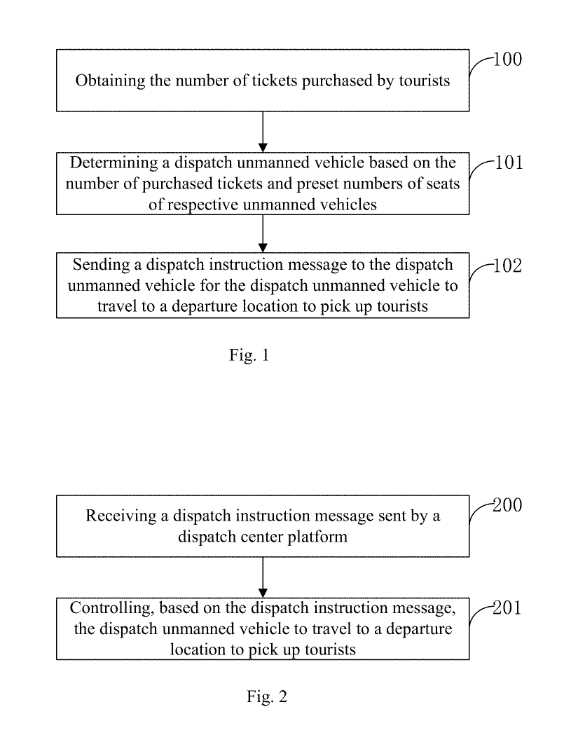

FIG. 1 is a flowchart of a first embodiment of the managing method for unmanned vehicles according to the present invention. As shown in FIG. 1, the managing method for unmanned vehicles according to the present embodiment may specifically include the steps of:

100. Obtaining the number of tickets purchased by tourists;

101. Determining a dispatch unmanned vehicle based on the number of purchased tickets and preset numbers of seats of respective unmanned vehicles;

102. Sending a dispatch instruction message to the dispatch unmanned vehicle for the dispatch unmanned vehicle to travel to a departure location to pick up tourists.

The execution body of the managing method for unmanned vehicles according to the present embodiment may particularly be a dispatch center platform.

In the tourist attraction spots, the vehicles of the attraction spots for users are scheduled based on the number of tourists; and the number of tourists is reflected by the number of tickets purchased by the tourists, which can be monitored by the dispatch center platform. The dispatch center platform can obtain the number of tickets purchased by the tourists, and then determine the number of unmanned vehicles to be dispatched based on the number of purchased tickets and the preset seat numbers of the unmanned vehicles, and then determine, from a plurality of unmanned vehicles, the unmanned vehicle to be dispatched. In particular, each unmanned vehicle to be dispatched has its own unique identifier, and the dispatch center platform can realize the dispatching and management of the vehicles according to the identifier of each unmanned vehicle. For example, the dispatch center platform can monitor the traveling time and the dispatched times of each unmanned vehicle on the same day, and carry out dispatching of vehicles through combining the balance of traveling time of each vehicle and the time difference between the last dispatched time of each vehicle and the current time. Specifically, the dispatch center platform may select, from the unmanned vehicles to be dispatched, the identifier of the vehicle with the minimum dispatch times and the time difference between the last dispatch time and the current time greater than the preset time threshold as the identifier of the dispatch unmanned vehicle. In the present embodiment, when the number of purchased tickets is less than or equal to the preset number of seats of one unmanned vehicle, the number of determined unmanned vehicles may be one; and when the number of tickets is larger than the preset number of seats of an unmanned vehicle, a plurality of unmanned vehicles may be dispatched. And then the dispatch center platform can send a dispatch instruction message to a corresponding unmanned vehicle based on the identifiers of respective dispatch unmanned vehicles, and the dispatch unmanned vehicle can receive the dispatch instruction message and be controlled to travel to the departure location to pick up tourists. In the attraction spots, in order to facilitate the management and dispatching of unmanned vehicles, unmanned vehicles can be provided in advance with dispatch locations, departure locations, and preset routes. The unmanned vehicle to be dispatched stays at the dispatching location, and the dispatch unmanned vehicle may travel to the departure location after receiving the dispatch instruction message, and the unmanned vehicle, after departing, can travel according to a preset route.

The managing method for unmanned vehicles according to the present embodiment obtains the number of tickets purchased by the tourists, determines a dispatch unmanned vehicle based on the number of purchased tickets and the preset number of seats of each unmanned vehicle by, sends a dispatch instruction message to the unmanned vehicle for the dispatch unmanned vehicle to travel to the departure location to pick up tourists. With the technical solution of the present embodiment, unmanned vehicles can be dispatched automatically by the dispatch center platform, to overcome the disadvantages of human operation of the attraction spot infrastructure in prior art, which can lead to high labor cost and low working efficiency. It can realize automatic dispatching of unmanned vehicles, and does not need manual dispatching or manual driving, thus effectively saving operating cost of the attraction spots. And through management and control of unmanned vehicles by the dispatch center platform, it is possible to greatly improve management precision of the infrastructure in attraction spots, effectively improve the operating efficiency of attraction spots, and improve the tourists' interest and experiences.

Further optionally, based on the technical solution of the embodiment shown in FIG. 1 as above, after step 102 of “sending a dispatch instruction message to the dispatch unmanned vehicle”, the method may further comprise the following steps:

(a1) detecting whether the dispatch unmanned vehicle arrives at the departure location, executing step (a2) when the dispatch unmanned vehicle arrives at the departure location; otherwise returning to step (a1) to continue with detecting;

(a2) sending a check-in instruction message to the dispatch unmanned vehicle, for the dispatch unmanned vehicle to start checking tickets of tourists and open a boarding passage so as to allow the tourists to board the car; executing step (a3);

(a3) detecting whether the number of tickets checked to be valid by the unmanned vehicle reaches a preset number of seats of the dispatch unmanned vehicle; when the number of tickets reaches a preset number of seats, executing step (a4); otherwise returning to step (a3) to continue with the detecting;

(a4) sending a check-in stop message to the dispatch unmanned vehicle, for the dispatch unmanned vehicle to stop ticket checking; executing step (a5)

(a5) sending a departure instruction message to the dispatch unmanned vehicle for the dispatch unmanned vehicle to start traveling in accordance with a preset route.

In the present embodiment, regarding the attraction spot management, the departure location may be set in advance, and the departure location may be one or more specified locations, and the tourists may wait for the unmanned vehicle at a specified location. The unmanned vehicle may, after receiving the dispatch instruction message, travel from the location for dispatching to the departure location. The dispatch center platform can monitor the unmanned vehicle in the whole process, and when the unmanned vehicle is detected to arrive at the departure location, it can send a check-in instruction message to the unmanned vehicle, which can be voice prompt message. Specifically, a check-in client can be installed in the dispatch unmanned vehicle, and after the dispatch unmanned vehicle receives the check-in instruction message, the check-in client can be started and then the identifier information of a ticket is obtained by the check-in client. The identifier information of the ticket in the present embodiment may be a bar code or a two-dimensional code on the ticket or the like for uniquely identifying the ticket. And then the identifier information of the ticket is sent to the check-in server for the ticket server to check the authenticity of the ticket and whether the ticket is reused according to the identifier information of the ticket. Specifically, the check-in server may be provided on the dispatch center platform side, for example, on the dispatch center platform. The check-in server may store the identifier information of the tickets in advance or may store the check-in rule of tickets in advance so that the check-in server may determine, based on the identifier information of the pre-stored tickets or the check-in rule of the tickets stored in advance to check whether a ticket is authentic; the ticket server also records whether the ticket has duplicate identifiers, for example, if the ticket has been checked in an identifier of being checked-in may be provided, if the ticket is checked in repeatedly, one can prompt the information that the ticket is being checked in repeatedly. Only when the ticket is checked to be authentic and is not checked in repeatedly in can the ticket be checked to be valid, at which time the dispatch unmanned vehicle can open the boarding passage, allowing tourists to the vehicle. Using the above method can check tickets for more than one tourists.

In addition, the dispatch center platform can check the number of tickets checked to be valid by the unmanned vehicle, for example, the dispatch unmanned vehicle can report to the dispatch center platform each time it checks a ticket to be valid. When the dispatch center platform detects that the number of tickets checked to be valid by the dispatch unmanned vehicle exceeds a preset number of seats of the dispatch unmanned vehicle, it can send a check-in stop message to the unmanned vehicle. The corresponding unmanned vehicle, after receiving the check-in stop message, closes the check-in client and stop the ticket checking. At this time, the dispatch center platform sends a departure instruction message to the dispatch unmanned vehicle. At this time, the dispatch unmanned vehicle can start to travel according to a preset route based on the departure instruction message.

Further optionally, on the basis of the technical solution of the above-described embodiment, when step (a3) detects the number of tickets dispatched by the dispatch unmanned vehicle is less than the preset number of seats of the unmanned vehicle, the method may include the steps of:

(b1) detecting whether the dispatch unmanned vehicle has stayed at the departure location for a time period greater than or equal to a preset duration; executing step (a5) when it is detected that the dispatch unmanned vehicle has stayed at the departure location for a time period greater than or equal to a preset duration; otherwise, executing step (a3).

That is, when the number of tickets checked to be valid by the dispatch unmanned vehicle reaches a preset number of seats for dispatch unmanned vehicles, or when the dispatch unmanned vehicle has stayed at the departure location for a time period greater than or equal to a preset duration, the dispatch center platform may send a departure instruction message to the dispatch unmanned vehicle for the dispatch unmanned vehicle to start traveling according to a preset route. Of course, before the dispatch center platform sends a departure instruction message to the dispatch unmanned vehicle, the method may further include: the center platform sends a check-in stop message to the dispatch unmanned vehicle.

In addition, as should be noticed, in this embodiment, when a plurality of unmanned vehicles are dispatched, a plurality of unmanned vehicles may be successively sent with dispatch instruction messages, and after a previous dispatch unmanned vehicle departs in accordance with the departure instruction message, a dispatch instruction message is sent to the next unmanned vehicle to be dispatched. Alternatively, the dispatch instruction messages may be sent to a plurality of unmanned vehicles to dispatched at the same time, and a plurality of dispatch unmanned vehicles travel to the departure station at the same time. At this time, the corresponding departure location can include an actual location with a larger geographical coverage, which can accommodate multiple dispatch unmanned vehicles for tourists.

In the managing method for unmanned vehicles according to the above-described embodiment, the check-in and departure of the unmanned vehicle are controlled by a dispatch center platform so that automatic check-in and automatic departure control of an unmanned vehicle can be realized. This can greatly improve management precision, and can effectively improve operating efficiency of attraction spots, and improve tourists' interest and experiences.

FIG. 2 is a flowchart of a second embodiment of the managing method for unmanned vehicles according to the present invention. As shown in FIG. 2, the managing method for unmanned vehicles according to the present embodiment may include the following steps:

200. Receiving a dispatch instruction message sent by a dispatch center platform,

In the embodiment, the dispatch instruction message is the number of tickets purchased by tourists and sent to a dispatch unmanned vehicle after the dispatch unmanned vehicle is determined based on the number of purchased tickets and preset numbers of seats of respective unmanned vehicles;

201. Controlling, based on the dispatch instruction message, the dispatch unmanned vehicle to travel to a departure location to pick up tourists.

The executing body of the management method for the unmanned vehicle according to the present embodiment is an unmanned vehicle. The embodiment of the managing method for unmanned vehicles according to the present embodiment is different from the embodiment shown in FIG. 1 in that the embodiment shown in FIG. 1 describes the technical solution of the present invention on the dispatch center platform side, while the present embodiment describes the technical solution of the present invention on the side of an unmanned vehicle. The specific implementation of the embodiment of the managing method for unmanned vehicles according to the present embodiment can be found with reference to the description of the embodiment shown in FIG. 1, which will not be described here in detail.

The managing method for unmanned vehicles according to the present embodiment receives a dispatch instruction message sent by a dispatch center platform, the dispatch instruction message being the number of tickets purchased by tourists obtained by the dispatch center platform and sent to a dispatch unmanned vehicle after the dispatch unmanned vehicle is determined based on the number of purchased tickets and preset numbers of seats of respective unmanned vehicles; and controls, based on the dispatch instruction message, the dispatch unmanned vehicle to travel to a departure location to pick up tourists. With the technical solution of the present embodiment, unmanned vehicles can be dispatched automatically by the dispatch center platform, to overcome the disadvantages of human operation of the attraction spot infrastructure in prior art, which can lead to high labor cost and low working efficiency. It can realize automatic dispatching of unmanned vehicles, and does not need manual dispatching or manual driving, thus effectively saving operating cost of the attraction spots. And through management and control of unmanned vehicles by the dispatch center platform, it is possible to greatly improve management precision of the infrastructure in attraction spots, effectively improve the operating efficiency of attraction spots, and improve the tourists' interest and experiences.

Based on the technical solution of the embodiment shown in FIG. 2, after the step 201 “controlling, based on the dispatch instruction message, the dispatch unmanned vehicle to travel to a departure location”, the method may further include the following steps:

(c1) receiving, after the vehicle travels to the departure location, a check-in instruction message sent by the dispatch center platform;

(c2) obtaining identifier information of the ticket of a tourist based on the check-in instruction message;

(c3) sending the identifier information of the ticket to a check-in server for the check-in server to check the authenticity of the ticket based on the identifier information of the ticket and to check whether the ticket is checked in repeatedly;

(c4) receiving checking information of the ticket returned by the check-in server;

(c5) performing corresponding processing based on the checking information of the ticket.

Specifically, the steps (c1) to (c3) of the present embodiment can be specifically found in the description of the steps (a1) to (a2) in the above-described embodiment, whose detailed description will be omitted here.

After the check-in server checks the authenticity of the ticket and whether the ticket is checked in repeatedly based on the identifier information of the ticket, the checking information may be sent to the dispatch unmanned vehicle. Specifically, the checking information may include the following three cases: (1) the ticket is authentic and is not checked in repeatedly in; (2) the ticket is authentic and is checked in repeatedly; (3) the ticket is not authentic.

Specifically, regarding the three types of checking information, the step (c5) “performing corresponding processing based on the checking information of the ticket” and may specifically include:

opening a boarding passage to allow the tourist to board the vehicle if the ticket is authentic and is not checked in repeatedly in;

issuing a prompt message stating that the ticket has been checked in and no boarding is allowed if the ticket is authentic but has been checked in repeatedly;

issuing a prompt message stating that the ticket is faked and no boarding is allowed if the ticket is faked.

Specifically, when the current dispatch unmanned vehicle receives the checking information that the ticket is authentic and is not checked in repeatedly, it is determined that the passenger can be allowed to board the vehicle, and the unmanned vehicle can be controlled to open the boarding passage. If the ticket is authentic, but is checked in repeatedly, the unmanned vehicle can issue the prompt message of “the ticket has been checked in, no boarding is allowed”. When the ticket is faked, the unmanned vehicles directly issues a prompt message of “the ticket is faked, no boarding is allowed”. The prompt message in the present embodiment may be a text prompt message or a voice prompt message.

Further optionally, on the basis of the technical solution of the above embodiment, it is also possible to include: sending a message stating that the ticket is checked to be valid to the dispatch center platform so as to enable the dispatch center platform to count the number of tickets checked to be valid, if the ticket is authentic and is not checked in repeatedly. In this way, the dispatch center platform can monitor the tickets that have been checked in at all times so as to determine the number of passengers in the vehicle that have been checked in and uploaded by the current dispatching center, so that the dispatch center platform can determine whether the current dispatch unmanned vehicle is already filled up based on the number of tickets that have checked to be valid. If the number of the checked tickets reaches a preset number of seats of the current dispatch unmanned vehicle, it is determined whether the current dispatch unmanned vehicle has been filled up. In addition, the dispatch center platform can also check the time the dispatch unmanned vehicle has stayed at the departure location, and avoid long time waiting of the tourists in the departure location.

Accordingly, it is further possible to further include, on the basis of the technical solution of the above-mentioned embodiment, after the step of “sending a message stating that the ticket is checked to be valid to the dispatch center platform”, the following steps:

(d1) receiving a check-in stop message sent by the dispatch center platform if the number of tickets checked to be valid by the dispatch unmanned vehicle reaches a preset number of seats of the dispatch unmanned vehicle or the dispatch unmanned vehicle has stayed at the departure location for a time period greater than or equal to a preset duration;

(d2) stopping check-in based on the check-in stop message;

(d3) receiving a departure instruction message sent by the dispatch center platform;

(d4) starting traveling according to a preset route based on the departure instruction message.

Specifically, the steps (d1) to (d4) of the present embodiment can be specifically found in the description of the steps (a1) to (a5) in the above-described embodiment, whose detailed description will be omitted here.

Further optionally, after the step (d4) of the above-described embodiment, the following steps may also be included:

(e1) displaying a tour route map of a preset route and information of all attraction spots;

(e2) displaying a selection box for the attraction spots;

(e3) receiving selection information of the attraction spot selected by a tourist based on the selection box of the attraction spots;

(e4) issuing a disembarking instruction message upon arrival at the attraction spot selected by the tourist.

Specifically, for example, a display module may be provided behind each seat of the unmanned vehicle to display a tour route map of a preset route and information of all the attraction spots on the tour route. The display module of the present embodiment may be embodied in particular with an electronic device having a playback and display function, which is part of an unmanned vehicle. In particular, the display module is disposed behind each seat for a user in the back row of the seat to view and listen to information displayed by the display module. At the same time, the display module can be equipped with headphones, which can be used by tourists to listen to the audio played by the display module.

With the display module, it is possible to display a tour route map of a preset route and display information of all the attraction spots on the tour route by voice and text. During displaying of information for each attraction spot, one can display a selection box for each attraction spot for the user to choose whether to get off at the attraction spot. Then, the dispatch unmanned vehicle receives the selection information of the attraction spot selected by the tourist according to the selection boxes of respective spots and sends out alerting information through voice announcement when the unmanned vehicle arrives at a certain tourist attraction spot.

With the managing method for unmanned vehicles according to the above-described embodiment, unmanned vehicles can be dispatched automatically by the dispatch center platform, to overcome the disadvantages of human operation of the attraction spot infrastructure in prior art, which can lead to high labor cost and low working efficiency. It can realize automatic dispatching of unmanned vehicles, and does not need manual dispatching or manual driving, thus effectively saving operating cost of the attraction spots. And through management and control of unmanned vehicles by the dispatch center platform, it is possible to greatly improve management precision of the infrastructure in attraction spots, and effectively improve the operating efficiency of attraction spots. The method for managing the unmanned vehicle according to the present embodiment is also capable of displaying the tourist route map and the information of all the attraction spots of the preset route to the tourists and receiving the selection information of the attraction spot selected by a tourists based on the selection boxes of the respective attraction spots, so as to issue a message to remind the tourist to get off, when the tourist reaches the selected attraction spot, which enriches the function of unmanned vehicles, increases the convenience of tourists travel, and improves the tourist's interest and experiences.

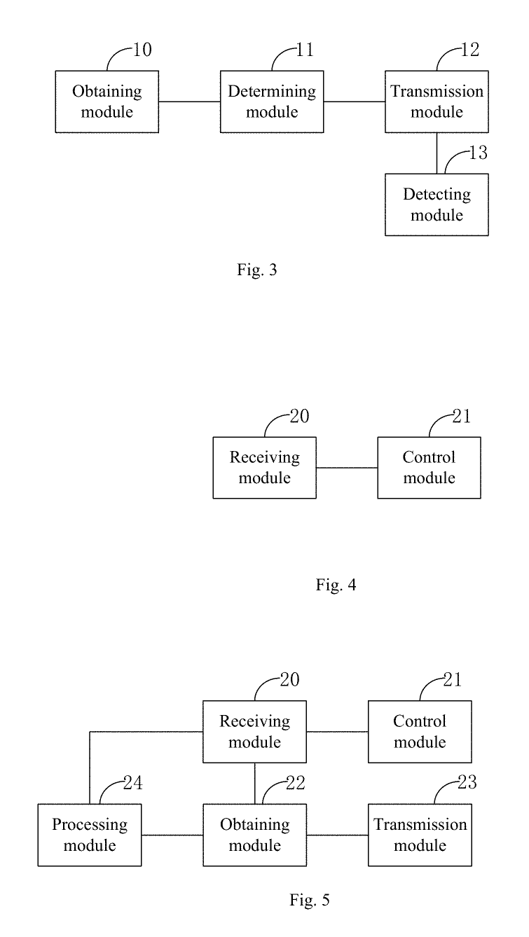

FIG. 3 is a schematic structural view of an embodiment of a dispatch center platform according to the present invention. As shown in FIG. 3, the dispatch center platform of the present embodiment includes an obtaining module 10, a determining module 11, and a transmission module 12.

The obtaining module 10 is used for obtaining the number of tickets purchased by tourists; the determining module 11 is used for determining a dispatch unmanned vehicle based on the number of purchased tickets obtained by the obtaining module 10 and preset numbers of seats of respective unmanned vehicles; the transmission module 12 is used for sending a dispatch instruction message to the dispatch unmanned vehicle determined by the determining module 11 for the dispatch unmanned vehicle to travel to a departure location to pick up tourists.

The management center of the dispatch center platform according to the present embodiment can realize the management of unmanned vehicles by using the above-mentioned module with the same implementation principle and the same technical effect of related embodiments of the method, and the detailed description of the related embodiments of the method is omitted.

Further optionally, the dispatch center platform of the present embodiment may further include a detection module 13, as shown in FIG. 3. Herein, the detecting module 13 is used for detecting whether the dispatch unmanned vehicle arrives at the departure location; the transmission module 12 is also used for sending a check-in instruction message to the dispatch unmanned vehicle when the detecting module 13 detects that the dispatch unmanned vehicle arrives at the departure location, for the dispatch unmanned vehicle to start checking tickets of tourists and open a boarding passage so as to allow the tourists to board the car.

The detecting module 13 is also used for detecting whether the number of tickets checked to be valid by the unmanned vehicle reaches a preset number of seats of the dispatch unmanned vehicle; the transmission module 12 is also used for sending, when the detecting module 13 detects that the number of tickets checked to be valid reaches a preset number of seats, a check-in stop message to the dispatch unmanned vehicle, for the dispatch unmanned vehicle to stop ticket checking.

The transmission module 12 is also used for sending a departure instruction message to the dispatch unmanned vehicle for the dispatch unmanned vehicle to start traveling in accordance with a preset route.

Further optionally, the detecting module 13 is also used for further detecting whether the dispatch unmanned vehicle has stayed at the departure location for a time period greater than or equal to a preset duration when it is detected that the number of tickets checked to be valid by the dispatch unmanned vehicle does not reach the preset number of seats of the dispatch unmanned vehicle; the transmission module 12 is also used for sending a departure instruction message to the dispatch unmanned vehicle when the detecting module 13 detects that the dispatch unmanned vehicle has stayed at the departure location for a time period greater than or equal to a preset duration.

The management center of the dispatch center platform according to the above embodiment can realize the management of unmanned vehicles by using the above-mentioned module with the same implementation principle and the same technical effect of related embodiments of the method, and the detailed description of the related embodiments of the method is omitted.

FIG. 4 is a schematic structural view of an unmanned vehicle according to a first embodiment of the present invention. As shown in FIG. 4, the unmanned vehicle according to the present embodiment may in particular include a receiving module 20 and a control module 21.

The receiving module 20 is used for receiving a dispatch instruction message sent by a dispatch center platform, the dispatch instruction message being the number of tickets purchased by tourists obtained by the dispatch center platform and sent to a dispatch unmanned vehicle after the dispatch unmanned vehicle is determined based on the number of purchased tickets and preset numbers of seats of respective unmanned vehicles. The control module 21 is used for controlling, based on the dispatch instruction message received by the receiving module 20, the dispatch unmanned vehicle to travel to a departure location to pick up tourists.

In the unmanned vehicle according to the present embodiment, the management of the unmanned vehicle by using the above-mentioned module has the same principle and technical effect as the related embodiments of the method as described above, and detailed description of the related embodiments of the method is omitted.

FIG. 5 is a schematic structural view of an unmanned vehicle according to a second embodiment of the present invention. As shown in FIG. 5, the unmanned vehicle according to the present embodiment further describes the technical solution of the present invention in more detail on the basis of the technical solution of the embodiment shown in FIG. 4.

As shown in FIG. 5, the unmanned vehicle of the present embodiment may further include an obtaining module 22, a transmission module 23, and a processing module 24.

The receiving module 20 is also used for receiving, after the vehicle travels to the departure location, a check-in instruction message sent by the dispatch center platform; the obtaining module 22 is used for obtaining identifier information of the ticket of a tourist based on the check-in instruction message received by the receiving module 20; the transmission module 23 is used for sending the identifier information of the ticket obtained by the obtaining module 22 to a check-in server for the check-in server to check the authenticity of the ticket based on the identifier information of the ticket and to check whether the ticket is checked in repeatedly; the receiving module 20 is also used for receiving checking information of the ticket returned by the check-in server; the processing method 24 is used for performing corresponding processing based on the checking information of the ticket received by the receiving module 20.

Further optionally, the processing module 24 is specifically used for opening a boarding passage to allow the tourist to board the vehicle if the ticket in the checking information of the ticket received by the receiving module 20 is authentic and is not checked in repeatedly.

The processing module 24 is specifically used for issuing a prompt message stating that the ticket has been checked in and no boarding is allowed if the ticket in the checking information of the ticket received by the receiving module 20 is authentic but is checked in repeatedly.

The processing module 24 is specifically used for issuing a prompt message stating that the ticket in the checking information of the ticket received by the receiving module 20 is faked and no boarding is allowed if the ticket is faked.

The processing module 24 is particularly adapted to receive the ticket information from the receiving module 20 if the ticket is true but is checked in repeatedly to issue a ticket that has been checked and rejects the on-board alert message.

Further optionally, the sending module 23 is also used for sending a message stating that the ticket is checked to be valid to the dispatch center platform so as to enable the dispatch center platform to count the number of tickets checked to be valid, if the ticket is authentic and is not checked in repeatedly.

Further optionally, the receiving module 20 of the present embodiment is also used for receiving a check-in stop message sent by the dispatch center platform if the number of tickets checked to be valid by the dispatch unmanned vehicle reaches a preset number of seats of the dispatch unmanned vehicle or the dispatch unmanned vehicle has stayed at the departure location for a time period greater than or equal to a preset duration.

The control module 21 is also used for stopping check-in based on the check-in stop message.

The receiving module 20 is also used for receiving a departure instruction message sent by the dispatch center platform.

The control module 21 is also used for starting traveling according to a preset route based on the departure instruction message.

Further, as shown in FIG. 5, the unmanned vehicle of the present embodiment may further include a display module 25.

The displaying module 25 is used for displaying a tour route map of a preset route and information of all attraction spots; the displaying module 25 is provided at the back of the seat of an unmanned vehicle; the displaying module 25 is also used for displaying a selection box for the attraction spots; the receiving module 20 is also used for receiving selection information of the attraction spot selected by a tourist based on the selection box of the attraction spots; the processing module 24 is also used for issuing a disembarking instruction message upon arrival at the attraction spot selected by the tourist.

In the unmanned vehicle according to the present embodiment, the management of the unmanned vehicle by using the above-mentioned module has the same principle and technical effect as the related embodiments of the method as described above, and detailed description of the related embodiments of the method is omitted.

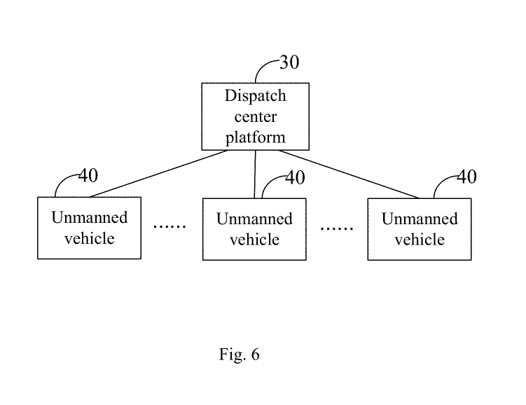

FIG. 6 is a structural diagram of an embodiment of a management system for unmanned vehicles according to the present invention. As shown in FIG. 6, the management system for unmanned vehicles according to the present embodiment may include, in particular, a dispatch center platform 30 and at least one unmanned vehicle 40. The dispatch center platform 30 is communicatively connected to each unmanned vehicle 40, to carry out management of the unmanned vehicle 40.

In the present embodiment, the dispatch center platform 30 employs a dispatch center platform as in the embodiment shown in FIG. 3; each of the unmanned vehicles 40 employs the unmanned vehicle of the embodiment shown in FIG. 4 or FIG. 5, and specifically, managing of unmanned vehicles can be realized with the managing method of unmanned vehicle of the embodiment shown the above FIG. 1 or 2, whose detail can be found in the above-described related embodiments, and the detailed description thereof will be omitted.

As should be understood, in the various embodiments of the present invention, the disclosed systems, devices, and methods can be implemented through other ways. For example, the embodiments of the devices described above are merely illustrative. For example, the division of the units is only a logical functional division, the division may be done in other ways in actual implementations.

The units described as separate members may be or may be not physically separated, the components shown as units may or may not be physical units, which can be located in one place, or distributed in a number of network units. One can select some or all of the units to achieve the purpose of the embodiments according to the embodiment of the actual needs.

Further, in the embodiment of the present invention, the functional units in each embodiment may be integrated in a processing unit, or each unit may be a separate physical existence, or two or more units can be integrated in one unit. The integrated units described above can be used both in the form of hardware, or in the form of software plus hardware.

The aforementioned integrated unit implemented in the form of software may be stored in a computer readable storage medium. Said functional units of software are stored in a storage medium, including a number of instructions to instruct a computer device (it may be a personal computer, server, or network equipment, etc.) or processor to perform some steps of the method described in various embodiments of the present invention. The aforementioned storage medium includes: U disk, removable hard disk, read-only memory (ROM), a random access memory (RAM), magnetic disk, or an optical disk medium may store program code.

Finally, as should be noted, the above embodiments are merely preferred embodiments of the present invention, not intended to limit them; any modifications or replacements within the spirit of the present invention falls into the scope of the present invention.

We claim:

1. A managing method for unmanned vehicles, wherein the method comprises:
obtaining the number of tickets purchased by tourists;
determining a dispatch unmanned vehicle based on the number of purchased tickets and preset numbers of seats of respective unmanned vehicles;
sending a dispatch instruction message to the dispatch unmanned vehicle for the dispatch unmanned vehicle to travel to a departure location to pick up tourists.

2. The method according to claim 1, wherein after the step of sending a dispatch instruction message to the dispatch unmanned vehicle, the method further comprises:
detecting whether the dispatch unmanned vehicle arrives at the departure location;
sending a check-in instruction message to the dispatch unmanned vehicle when the dispatch unmanned vehicle arrives at the departure location, for the dispatch unmanned vehicle to start checking tickets of tourists, and open a boarding passage when the checking is successful so as to allow the tourists to board the car;
detecting whether the number of tickets checked to be valid by the unmanned vehicle reaches a preset number of seats of the dispatch unmanned vehicle;
sending, when the number of tickets checked to be valid reaches the preset number of seats, a check-in stop message to the dispatch unmanned vehicle, for the dispatch unmanned vehicle to stop ticket checking;
sending a departure prompt message to the dispatch unmanned vehicle for the dispatch unmanned vehicle to start traveling in accordance with a preset route.

3. The method according to claim 2, wherein the method further comprises:
further detecting whether the dispatch unmanned vehicle has stayed at the departure location for a time period greater than or equal to a preset duration when it is detected that the number of tickets checked to be valid by the dispatch unmanned vehicle does not reach the preset number of seats of the dispatch unmanned vehicle;
sending a departure prompt message to the dispatch unmanned vehicle when it is detected that the dispatch unmanned vehicle has stayed at the departure location for a time period greater than or equal to a preset duration.

4. A managing method for unmanned vehicles, wherein the method comprises:
receiving a dispatch instruction message sent by a dispatch center platform, the dispatch instruction message being the number of tickets purchased by tourists obtained by the dispatch center platform and sent to a dispatch unmanned vehicle after the dispatch unmanned vehicle is determined based on the number of purchased tickets and preset numbers of seats of respective unmanned vehicles;
controlling, based on the dispatch instruction message, the dispatch unmanned vehicle to travel to a departure location to pick up tourists.

5. The method according to claim 4, wherein, after the step of controlling, based on the dispatch instruction message, the dispatch unmanned vehicle to travel to a departure location, the method further comprises:
receiving, after the vehicle travels to the departure location, a check-in instruction message sent by the dispatch center platform;
obtaining identifier information of the ticket of a tourist based on the check-in instruction message;
sending the identifier information of the ticket to a check-in server for the check-in server to check the authenticity of the ticket and whether the ticket is checked repeatedly based on the identifier information of the ticket;
receiving checking information of the ticket returned by the check-in server;
and performing corresponding processing based on the checking information of the ticket.

6. The method according to claim 5, wherein performing corresponding processing based on the checking information of the ticket comprises:
opening a boarding passage to allow the tourist to board the vehicle if the ticket is authentic and is not checked in repeatedly;
issuing a prompt message stating that the ticket has been checked in and no boarding is allowed if the ticket is authentic but is checked in repeatedly;
issuing a prompt message stating that the ticket is faked and no boarding is allowed if the ticket is faked,
further, the method also comprises:
sending a message stating that the ticket is checked to be valid to the dispatch center platform so as to enable the dispatch center platform to count the number of tickets checked to be valid, if the ticket is authentic and is not checked in repeatedly.

7. The method according to claim 5, wherein after the step of sending a message stating that the ticket is checked to be valid to the dispatch center platform, the method further comprises:
receiving a check-in stop message sent by the dispatch center platform if the number of tickets checked to be valid by the dispatch unmanned vehicle reaches a preset number of seats of the dispatch unmanned vehicle or the dispatch unmanned vehicle has stayed at the departure location for a time period greater than or equal to a preset duration;
stopping check-in based on the check-in stop message;
receiving a departure prompt message sent by the dispatch center platform;
and starting traveling according to a preset route based on the departure prompt message.

8. The method according to claim 7, wherein after traveling according to a preset route based on the departure prompt message, the method further comprises:
displaying a tour route map of a preset route and information of all attraction spots;
displaying a selection box for the attraction spots;
receiving selection information of the attraction spot selected by a tourist based on the selection box of the attraction spots;
issuing a getting-off prompt message upon arrival at the attraction spot selected by the tourist.

9. An apparatus, comprising
one or more processor;
a memory;
one or more programs stored in the memory and configured to execute the following operation when executed by the one or more processors:
obtaining the number of tickets purchased by tourists;
determining a dispatch unmanned vehicle based on the number of purchased tickets and preset numbers of seats of respective unmanned vehicles;
sending a dispatch instruction message to the dispatch unmanned vehicle for the dispatch unmanned vehicle to travel to a departure location to pick up tourists.

10. The Apparatus according to claim 9, wherein after the operation of sending a dispatch instruction message to the dispatch unmanned vehicle, the operation further comprises:
detecting whether the dispatch unmanned vehicle arrives at the departure location;
sending a check-in instruction message to the dispatch unmanned vehicle when the dispatch unmanned vehicle arrives at the departure location, for the dispatch unmanned vehicle to start checking tickets of tourists, and open a boarding passage when the checking is successful so as to allow the tourists to board the car;
detecting whether the number of tickets checked to be valid by the unmanned vehicle reaches a preset number of seats of the dispatch unmanned vehicle;
sending, when the number of tickets checked to be valid reaches the preset number of seats, a check-in stop message to the dispatch unmanned vehicle, for the dispatch unmanned vehicle to stop ticket checking;
sending a departure prompt message to the dispatch unmanned vehicle for the dispatch unmanned vehicle to start traveling in accordance with a preset route.

11. The Apparatus according to claim 10, wherein the operation further comprises:
further detecting whether the dispatch unmanned vehicle has stayed at the departure location for a time period greater than or equal to a preset duration when it is detected that the number of tickets checked to be valid by the dispatch unmanned vehicle does not reach the preset number of seats of the dispatch unmanned vehicle;
sending a departure prompt message to the dispatch unmanned vehicle when it is detected that the dispatch unmanned vehicle has stayed at the departure location for a time period greater than or equal to a preset duration.

12. An apparatus, comprising
one or more processor;
a memory;
one or more programs stored in the memory and configured to execute the following operation when executed by the one or more processors:
receiving a dispatch instruction message sent by a dispatch center platform, the dispatch instruction message being the number of tickets purchased by tourists obtained by the dispatch center platform and sent to a dispatch unmanned vehicle after the dispatch unmanned vehicle is determined based on the number of purchased tickets and preset numbers of seats of respective unmanned vehicles;
controlling, based on the dispatch instruction message, the dispatch unmanned vehicle to travel to a departure location to pick up tourists.

13. The Apparatus according to claim 12, wherein, after the operation of controlling, based on the dispatch instruction message, the dispatch unmanned vehicle to travel to a departure location, the operation further comprises:
receiving, after the vehicle travels to the departure location, a check-in instruction message sent by the dispatch center platform;
obtaining identifier information of the ticket of a tourist based on the check-in instruction message;
sending the identifier information of the ticket to a check-in server for the check-in server to check the authenticity of the ticket and whether the ticket is checked repeatedly based on the identifier information of the ticket;
receiving checking information of the ticket returned by the check-in server;
and performing corresponding processing based on the checking information of the ticket.

14. The Apparatus according to claim 13, wherein performing corresponding processing based on the checking information of the ticket comprises:
opening a boarding passage to allow the tourist to board the vehicle if the ticket is authentic and is not checked in repeatedly;
issuing a prompt message stating that the ticket has been checked in and no boarding is allowed if the ticket is authentic but is checked in repeatedly;
issuing a prompt message stating that the ticket is faked and no boarding is allowed if the ticket is faked,
further, the operation also comprises:
sending a message stating that the ticket is checked to be valid to the dispatch center platform so as to enable the dispatch center platform to count the number of tickets checked to be valid, if the ticket is authentic and is not checked in repeatedly.

15. The Apparatus according to claim 13, wherein after the operation of sending a message stating that the ticket is checked to be valid to the dispatch center platform, the operation further comprises:
receiving a check-in stop message sent by the dispatch center platform if the number of tickets checked to be valid by the dispatch unmanned vehicle reaches a preset number of seats of the dispatch unmanned vehicle or the dispatch unmanned vehicle has stayed at the departure location for a time period greater than or equal to a preset duration;
stopping check-in based on the check-in stop message;
receiving a departure prompt message sent by the dispatch center platform;
and starting traveling according to a preset route based on the departure prompt message.

16. The Apparatus according to claim 15, wherein after traveling according to a preset route based on the departure prompt message, the operation further comprises:
displaying a tour route map of a preset route and information of all attraction spots;
displaying a selection box for the attraction spots;
receiving selection information of the attraction spot selected by a tourist based on the selection box of the attraction spots;
issuing a getting-off prompt message upon arrival at the attraction spot selected by the tourist.
